(19) United States
(12) Patent Application Publication
(10) Pub. No.: US 2007/0252512 A1
(43) Pub. Date: Nov. 1, 2007

(54) Electroluminescent Structure and Led with an El Structure

(75) Inventors: Dietrich Bertram, Aachen (DE); Thomas Juestel, Witten (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,716

(22) PCT Filed: Jun. 1, 2005
(86) PCT No.: PCT/IB05/51778

§ 371 Date: Nov. 28, 2006

(30) Foreign Application Priority Data
Jun. 4, 2004 (EP) 04102534.7

(51) Int. Cl. H05B 33/14; H01J 1/63

(52) U.S. Cl. 313/503; 313/506

(57) ABSTRACT

An EL structure is described, with a single ultraviolet or blue light emitting layer that is connected to a back electrode. The top surface comprises three separate segments for the primary colors red, green and blue. Another single phosphorescent blend or a two-component phosphorescent blend is deposited on at least two of the three segments. Each of the three segments can be individually driven by a corresponding top electrode. Thus, a single chip solution is provided for a LED with tunable visible light.

The invention relates to an electroluminescent (EL) structure, particularly a light-emitting diode (LED) with an EL structure. Light from a LED can be partially converted by means of phosphor conversion to generate a mixed color or a white color by conversion of a lower energy color than the pure LED. The phosphor conversion has the drawback that it is not possible to tune the resulting color, because the phosphor has a fixed emission characteristic.

WO97/48138 discloses visible light-emitting devices including UV light-emitting diodes and UV-excitable visible light-emitting phosphors. In these LEDs, an epitaxial buffer-contact layer of n+ GaN is located on a single crystal substrate, on which layer the LED structure including the following epitaxial layers is arranged in sequence: a lower cladding layer of n AlGaN, an active region i GaN, and an upper cladding layer of p AlGaN. A p+ GaN contact layer is provided on top of this LED structure, while a semi-transparent contact layer of, for example, an Au/Ni alloy, and a voltage electrode, with a phosphor layer of a UV-excitable phosphor on the contact layer metallization layers of, for example, Al are provided on the surface buffer/contact layer on either side of the LED structure. A further layer provides grounding via a grounding electrode, while another layer serves as an addressing electrode. WO97/48 138 mentions as typical UV-excitable phosphors which may be used for the LED:

| | |
|---|---|
| red: | Y₂O₂S: Eu |
| green: | ZnS: Cu, Ag, Au |
| blue: | BaMgAl₁₀O₁₇: Eu |

The visible light-emitting device of WO 97/48138 as a whole is tunable, because the color that is actually emitted is composed of red, green and blue. However, to achieve this tunability of the device as a whole, three UV light-emitting diodes, each provided with one of three different UV light-excitable phosphors with the characteristics red, blue or green, respectively, have to be handled and controlled.

It is therefore an object of the invention to provide a single EL structure that can be used for a LED, which emits a tunable color. It is another object to provide a method of obtaining white light or a tunable color light by means of mixing the primary colors red, green and blue and by means of phosphor conversion of the ultraviolet or blue light emitted by an emissive layer of the LED.

The object is achieved by an electroluminescent structure on a substrate layer with at least one emissive layer and one charge injection and/or transportation layer arranged on a back electrode, wherein
the top layer of the electroluminescent structure comprises two or more separate segments;
at least one of the two or more separate segments has a top electrode as front contact to be driven individually, and
at least one of the two or more separate segments has a phosphorescent blend on its surface, the phosphorescent blend being excitable by the light emitted by the emissive layer.

In accordance with the preferred embodiment, the EL structure comprises three separate segments.

This arrangement has a single back electrode, which serves as common back electrode for either of the two or more top electrodes. The common back electrode may either be connected to ground or arranged as a floating electrode. This EL structure may be arranged on a single chip. By separately driving the individual segments or sections, respectively, the corresponding area of the emissive layer becomes active and emits light which, by means of a phosphorescent coverage, may be converted into light of another wavelength. The wavelength depends on the material the phosphorescent coverage consists of. When a current flows from one top electrode to the back electrode, that part of the emissive layer through which the current flows emits light, which is used for the conversion by the phosphorescent coverage on top of this area. Only the active region, which is directly or indirectly sandwiched between the driven top electrode and the common back electrode, emits light.

The phosphorescent blend may consist of a single phosphor or a two-component phosphor blend.

In accordance with one embodiment, the emissive layer emits blue light with a wavelength of ˜430 nm to ˜485 nm, and the single phosphor or two-component phosphor blend is selected from the group consisting of:
a) (Y₁₋ₓGdₓ)₃(Al_{1-y}Ga_{y})₅O₁₂:Ce
b) (Sr₁₋ₓCaₓ)₂SiO₄:Eu
c) (Y₁₋ₓGdₓ)₃(Al_{1-y}Ga_{y})₅O₁₂:Ce+(Sr_{1-x-y}CaₓBa_{y})₂Si₅N₈:Eu
d) (Y₁₋ₓGdₓ)₃(Al_{1-y}Ga_{y})₅O₁₂:Ce+(Sr₁₋ₓCaₓ)S:Eu
e) (Lu₁₋ₓYₓ)₃(Al_{1-y}Ga_{y})₅O₁₂:Ce+(Sr_{1-x-y}CaₓBa_{y})₂Si₅N₈:Eu
f) (Lu₁₋ₓYₓ)₃(Al_{1-y}Ga_{y})₅O₁₂:Ce+(Sr₁₋ₓCaₓ)S:Eu
g) (Sr₁₋ₓCaₓ)Si₂N₂O₂:Eu+(Sr_{1-x-y}CaₓBa_{y})₂Si₅N₈:Eu
h) (Sr₁₋ₓCaₓ)Si₂N₂O₂:Eu+(Sr₁₋ₓCaₓ)S:Eu
i) (Ba₁₋ₓSrₓ)SiO₄:Eu+(Sr_{1-x-y}CaₓBa_{y})₂Si₅N₈:Eu
j) (Ba₁₋ₓSrₓ)SiO₄:Eu+(Sr₁₋ₓCaₓ)S:Eu
k) SrGa₂S₄:Eu+(Sr₁₋ₓCaₓ)S:Eu
l) SrGa₂S₄:Eu+(Sr_{1-x-y}CaₓBa_{y})₂Si₅N₈:Eu

wherein x=0.0 . . . 1.0.

In accordance with another embodiment, the electroluminescent structure has an emissive layer that emits ultraviolet light with a wavelength of ˜370 nm to ˜420 nm, and the single phosphor or two-component phosphor blend is selected from the group consisting of
m) BaMgAl₁₀O₁₇:Eu+(Sr_{1-z}Ca_{z})₂SiO₄:Eu
n) BaMgAl₁₀O₁₇:Eu+(Sr_{1-z}Ca_{z})Si₂N₂O₂:Eu+(Sr_{1-z-y}Ca_{z}Ba_{y})₂Si₅N₈:Eu
o) BaMgAl₁₀O₁₇:Eu+(Sr_{1-z}Ca_{z})Si₂N₂O₂:Eu+(Sr_{1-z}Ca_{z})S:Eu
p) BaMgAl₁₀O₁₇:Eu+(Ba_{1-z}Sr_{z})SiO₄:Eu+(Sr_{1-z-y}Ca_{z}Ba_{y})₂Si₅N₈:Eu
q) Sr₃MgSi₂O₈Eu+SrGa₂S₄:Eu+(Sr_{1-z-y}Ca_{z}Ba_{y})₂Si₅N₈:Eu
r) Sr₃MgSi₂O₈Eu+(Sr_{1-z}Ca_{z})₂SiO₄:Eu
s) Sr₃MgSi₂O₈Eu+(Sr_{1-z}Ca_{z})Si₂N₂O₂:Eu+(Sr_{1-z-y}Ca_{z}Ba_{y})₂Si₅N₈:Eu
t) Sr₃MgSi₂O₈Eu+(Sr_{1-z}Ca_{z})Si₂N₂O₂:Eu+(Sr_{1-z}Ca_{z})S:Eu
u) Sr₃MgSi₂O₈Eu+(Ba_{1-z}Sr_{z})SiO₄:Eu+(Sr_{1-z-y}Ca_{z}Ba_{y})₂Si₅N₈:Eu
v) Sr₃MgSi₂O₈Eu+SrGa₂S₄:Eu+(Sr_{1-z-y}Ca_{z}Ba_{y})₂Si₅N₈:Eu

wherein z=0.0 . . . 1.0.

The phosphorescent blend may be deposited directly or indirectly on top of the emissive layer by using electrostatic deposition. The structured application of the different phosphors can be realized by biasing every one of the different segments in such a way that the corresponding phosphorescent blend is being deposited or is independent of the bias applied. Further deposition methods may be electrostatic deposition, use of ceramic phosphorous dices, ink-jetting of suspensions, dispensing of mixtures of phosphorous blends and binder or carrier polymers.

The electroluminescent structure may be part of an electroluminescent arrangement, which further comprises one voltage or current source, either for all of the front contacts or for every single front contact, and a controlling unit for individually driving the front contacts. The three components green, red and blue can be mixed by individually driving the front contacts. The mixed light may have different portions of the components red, green and blue and is thus tunable. In order to achieve high color rendering, other or further components such as amber may be selected.

A light-emitting diode with the electroluminescent structure generates a tunable visible light, but is still easy to handle, because only one back electrode has to be contacted.

One advantage of the electroluminescent structure is that it may be arranged on a single chip, which has defined operating conditions.

The electroluminescent structure may be used as a light source or as a lamp and has the advantage of a relatively low heat emission.

With regard to the method of obtaining white light or a tunable color light by means of mixing the primary colors red, green and blue and by means of phosphor conversion of the ultraviolet or blue light emitted by an emissive layer of the LED, the object is achieved by the steps of
providing an electroluminescent arrangement with a structured surface comprising two or more segments, wherein a different phosphorescent blend is deposited on at least one of the two or more segments, and
individually driving the front contacts which are arranged on at least one of the two or more segments in order to tune the portions of the components, i.e. the different phosphorescent blends, for the generated visible light.

In order to achieve a high color rendering, further colors such as amber may be selected besides the primary colors red, green and blue.

The invention will be further explained in detail with reference to the accompanying drawings, wherein

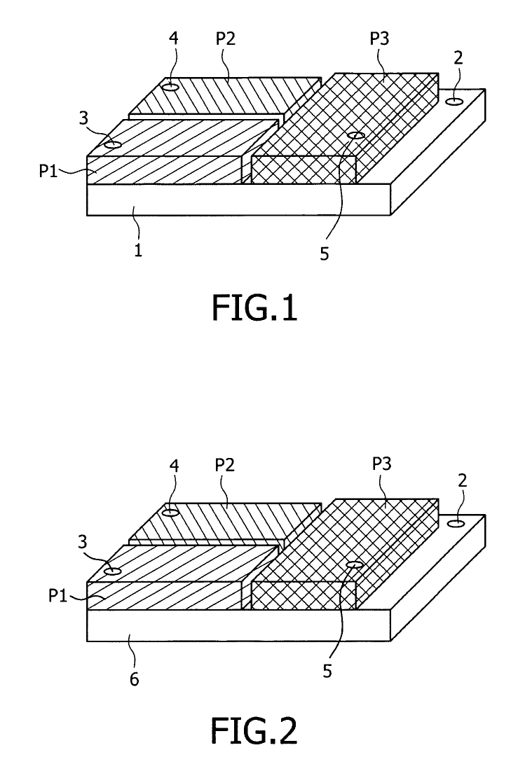

FIG. 1 is a perspective side view of a schematic EL structure with an ultraviolet light-emitting layer;

FIG. 2 is a perspective side view of a schematic EL structure with a blue light-emitting layer;

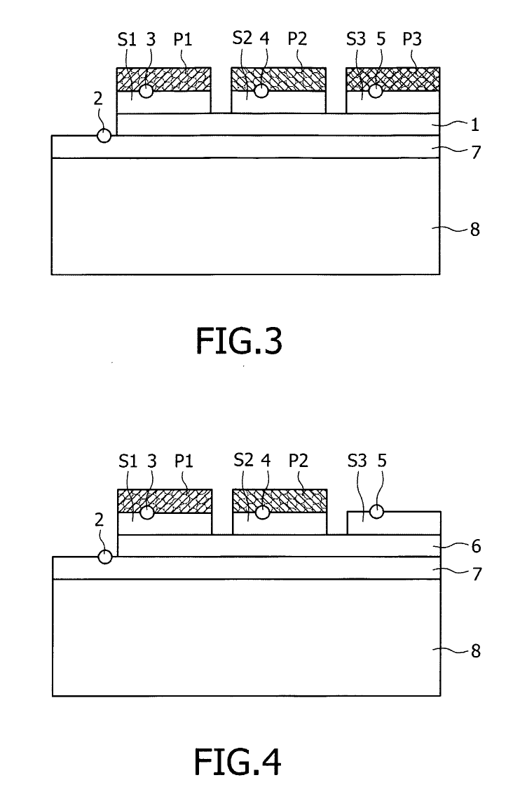

FIG. 3 is a cross-sectional view of a schematic ultraviolet light-emitting LED, and

FIG. 4 is a cross-sectional view of a schematic blue light-emitting LED.

FIG. 1 is a perspective side view of a schematic EL structure with an emissive layer 1 emitting ultraviolet light. The emissive layer 1 is provided with a back electrode 2 which, in this illustration, is arranged on top of the emissive layer 1, but may alternatively be arranged underneath the emissive layer as a further layer covering at least the area that is covered by the three segments of phosphorescent blends P1, P2, P3. Each phosphorescent blend P1, P2 and P3 is connected to a corresponding top voltage electrode 3, 4 or 5. When a voltage is applied so that a current flows from at least one of the top electrodes 3, 4 and 5 to the back electrode 2, or vice versa, the area of the emissive layer through which the current flows is activated. This means that the active area emits light, in this example ultraviolet light.

FIG. 2 is a perspective side view of a schematic EL structure as described with reference to FIG. 1, but with the difference that the emissive layer 6 emits blue light. This means that one of the three segments of the surface of the emissive layer may not be covered with a material that changes the wavelength, but with any transparent material or none at all.

FIG. 3 is a cross-sectional view of a schematic LED with a layer 1 emitting ultraviolet light and comprising three segments S1, S2 and S3 on its top surface. As illustrated, the phosphorous blends P1, P2 and P3 are deposited on the top surface of each segment S1, S2 and S3, but may also be deposited on the side walls. In this example, the back electrode 2 is connected to a non-insulated layer 7. Layer 7 preferably reflects light emitted by the emissive layer 1 in order to increase the amount of light rays, which reach and pass the phosphorescent blends. The substrate 8 on which the EL structure is arranged may be an InGaN-substrate.

FIG. 4 is a cross-sectional view of a schematic LED as described with reference to FIG. 3, but with the difference that the emissive layer 6 emits blue light. This means that one of the three segments of the surface of the emissive layer is not covered with a material that changes the wavelength, but with any transparent material.

In summary, the invention relates to an EL structure with a single ultraviolet or blue light-emitting layer that is connected to a back electrode. The top surface comprises three separate segments for the primary colors red, green and blue. Another single phosphorescent blend or a two-component phosphorescent blend is deposited on at least two of the three segments. Each of the three segments can be individually driven by a corresponding top electrode. Thus, a single chip solution is provided for a LED with tunable visible light.

1. An electroluminescent structure on a substrate layer with at least one emissive layer and one charge injection and/or transportation layer arranged on a back electrode, characterized in that
the top layer of the electroluminescent structure comprises two or more separate segments;
at least one of the two or more separate segments has a top electrode as front contact to be driven individually, and
at least one of the two or more separate segments has a phosphorescent blend on its surface, the phosphorescent blend being excitable by the light emitted by the emissive layer.

2. The electroluminescent structure of claim 1, characterized in that the phosphorescent blend consists of a single phosphor or a two-component phosphor blend.

3. The electroluminescent structure of claim 2, with an emissive layer that emits blue light (˜430 nm to ˜485 nm), characterized in that the single phosphor or two-component phosphor blend is selected from the group consisting of
a) (Y₁₋ₓGdₓ)₃(Al_{1-y}Ga_{y})₅O₁₂:Ce
b) (Sr₁₋ₓCaₓ)₂SiO₄:Eu
c) (Y₁₋ₓGdₓ)₃(Al_{1-y}Ga_{y})₅O₁₂:Ce+(Sr_{1-x-y}CaₓBa_{y})₂Si₅N₈:Eu
d) (Y₁₋ₓGdₓ)₃(Al_{1-y}Ga_{y})₅O₁₂:Ce+(Sr₁₋ₓCaₓ)S:Eu
e) (Lu₁₋ₓYₓ)₃(Al_{1-y}Ga_{y})₅O₁₂:Ce+(Sr_{1-x-y}CaₓBa_{y})₂Si₅N₈:Eu
f) (Lu₁₋ₓYₓ)₃(Al_{1-y}Ga_{y})₅O₁₂:Ce+(Sr₁₋ₓCaₓ)S:Eu
g) (Sr₁₋ₓCaₓ)Si₂N₂O₂:Eu+(Sr_{1-x-y}CaₓBa_{y})₂Si₅N₈:Eu
h) (Sr₁₋ₓCaₓ)Si₂N₂O₂:Eu+(Sr₁₋ₓCaₓ)S:Eu
i) (Ba₁₋ₓSrₓ)SiO₄:Eu+(Sr_{1-x-y}CaₓBa_{y})₂Si₅N₈:Eu
j) (Ba₁₋ₓSrₓ)SiO₄:Eu+(Sr₁₋ₓCaₓ)S:Eu
k) SrGa₂S₄:Eu+(Sr₁₋ₓCaₓ)S:Eu
l) SrGa₂S₄:Eu+(Sr_{1-x-y}CaₓBa_{y})₂Si₅N₈:Eu
wherein x=0,0 . . . 1,0.

3. The electroluminescent structure of claim 2, with an emissive layer that emits ultraviolet light (˜370 nm ˜420 nm), characterized in that the single phosphor or two-component phosphor blend is selected from the group consisting of
m) BaMgAl₁₀O₁₇:Eu+(Sr_{1-z}Ca_{z})₂SiO₄:Eu
n) BaMgAl₁₀O₁₇:Eu+(Sr_{1-z}Ca_{z})Si₂N₂O₂:Eu+(Sr_{1-z-y}Ca_{z}Ba_{y})₂Si₅N₈:Eu
o) BaMgAl₁₀O₁₇:Eu+(Sr_{1-z}Ca_{z})Si₂N₂O₂:Eu+(Sr_{1-z}Ca_{z})S:Eu
p) BaMgAl₁₀O₁₇:Eu+(Ba_{1-z}Sr_{z})SiO₄:Eu+(Sr_{1-z-y}Ca_{z}Ba_{y})₂Si₅N₈:Eu
q) Sr₃MgSi₂O₈Eu+SrGa₂S₄:Eu+(Sr_{1-z-y}Ca_{z}Ba_{y})₂Si₅N₈:Eu
r) Sr₃MgSi₂O_{8 Eu+(Sr}_{1-z}Ca_{z})₂SiO₄:Eu
s) Sr₃MgSi₂O₈Eu+(Sr_{1-z}Ca_{z})Si₂N₂O₂:Eu+(Sr_{1-z-y}Ca_{z}Ba_{y})₂Si₅N₈:Eu
t) Sr₃MgSi₂O₈Eu+(Sr_{1-z}Ca_{z})Si₂N₂O₂:Eu+(Sr_{1-z}Ca_{z})S:Eu
u) Sr₃MgSi₂O₈Eu+(Ba_{1-z}Sr_{z})SiO₄:Eu+(Sr_{1-z-y}Ca_{z}Ba_{y})₂Si₅N₈:Eu
v) Sr₃MgSi₂O₈Eu+SrGa₂S₄:Eu+(Sr_{1-z-y}Ca_{z}Ba_{y})₂Si₅N₈:Eu
wherein z=0,0 . . . 1,0.

5. An electroluminescent structure as claimed in claim 1, characterized in that the phosphorescent blends are deposited by using electrostatic deposition, ceramic phosphorous dices, ink-jetting of suspensions, dispensing of mixtures of phosphorous blends and binder or carrier polymers.

6. An electroluminescent arrangement comprising an electroluminescent structure as claimed in claim 1, one voltage/current source, either for all of the front contacts or for every single front contact, and a controlling unit for individually driving the front contacts.

7. A light-emitting diode with an electroluminescent structure as claimed in claim 1.

8. An electroluminescent structure as claimed in claim 1, characterized in that it is arranged on a single chip.

9. Use of an electroluminescent structure as claimed in claim 1, as a light source or as a lamp.

10. A method of obtaining white light from a light-emitting diode by means of mixing at least the primary colors red, green and blue and by means of phosphor conversion of the ultraviolet or blue light emitted by an emissive layer of the LED, characterized by the steps of
providing an electroluminescent arrangement with a structured surface comprising two or more segments, wherein a different phosphorescent blend is deposited on at least one of the two or more segments, and
individually driving the front contacts which are arranged on at least one of the two or more segments in order to tune the portions of the components for the generated visible light.
